(19) United States
(12) Patent Application Publication
(10) Pub. No.: US 2003/0131093 A1
(43) Pub. Date: Jul. 10, 2003

(54) System for generating usage data in a distributed information processing environment and method therefor

(75) Inventors: Sean Edward Aschen, New Haven, CT (US); James R. Doran, New Milford, CT (US); Brian Paul Olore, Monroe, NY (US); Christine Lynn Quintero, Poughkeepsie, NY (US)

Correspondence Address: Barry S. Newberger, 5400 Renaissance Tower, 1201 Elm Street, Dallas, TX, 75270, US

(73) Assignee: International Business Machines Corporation, Armonk, NY

(21) Appl. No.: 10/042,498

(22) Filed: Jan. 9, 2002

(51) Int. Cl. G06F 15/16

(52) U.S. Cl. 709/224; 709/217

(57) ABSTRACT

Systems and methods for generating usage statistics in a distributed information processing environment are implemented. These include, respectively, circuitry and steps for generating usage statistical information that include, respectively circuitry and steps for starting an log file parser on each server of a set of servers in a distributed information processing environment. Usage information is retrieved from a database file generated by the log file parser, and preselected usage statistical information generated from the usage information from the database file.

### TECHNICAL FIELD

The present invention relates in general to data processing systems, and in particular to collecting workload data in a distributed information processing system and generating near real-time usage information therefrom.

### BACKGROUND INFORMATION

Modern information systems, particularly in enterprise environments are increasingly reliant on the use of distributed resources to provide information services to users. These resources may include both hardware services, such as printing services as well as software resources, such as the familiar e-mail services, database management services (DBMS), as well as other, specialized application services particular to the enterprise, for example, underwriting rating services. Information describing the various users, applications, files, printers and other resources accessible in a multi-user environment is often collected into a special database which may be referred to as a directory. The Lightweight Directory Access Protocol (LDAP) is an open architecture set of protocols for accessing and updating information in a directory. (LDAP version 2 is defined in Request for Comments (RFC) 1777, and LDAP version 3 is specified in RFC 2251, December 1997 (copyright, The Internet Society, 1997)). RFC 1777 and RFC 2251 are hereby incorporated herein by reference. In the LDAP, the basic unit of information stored in the directory is referred to as an entry. Entries represent objects of interest, for example, in a multi-user data processing system environment, people, servers, organizations, etc. Entries are composed of a collection of attributes that contain information about the object. Every attribute has a type and one or more values. The LDAP itself does not specify a particular storage mechanism for the directory. For example, the directory storage mechanism may be implemented using flat files, a binary tree (b-tree) or a relational database.

The allocation and management of resources in such a distributed information processing environment as well as maintaining a secure environment, presents challenges to system administrators and managers. Although usage data may be collected by the directory server. For example an LDAP server may maintain an audit log that records login and logout information each time a user accesses the system as well as data on search queries, additions, deletions and other modifications. For example, a snippet from an audit log from an LDAP server is illustrative (for purposes of discussion, alphabetic labeling of the lines has been added):

a. 2001-09-10-06:59:59.645-07:00DST--V2 anonymous Search--bindDN:

b. <*CN=NULLDN*>--client: 10.30.1.27:55832--connectionID: 80825--received:

c. 2001-09-10-06:59:59.550-07:OODST--Success

d. base: ou=bluepages,o=ibm.cm

e. scope: wholeSubtree

f. derefAliases: neverDerefAliases

g. typesOnly: false

h. filter: (sn=GRANATH*)

i. attributes: callupname, tieline, internalemail, jobresponsibilities, uid

j. 2001-09-10-06:59:59.657-07:00DST--V2 anonymous Unbind--bindDN:

k. <*CN=NULLDN*>--client: 10.30.1.27:55832--conectionID: 80825--received:

l. 2001-09-10-06:59:59.657-07:00DST--Success

m. 2001-09-10-07:00:00.011-07:00DST--V? unauthenticated Search--bindDN:

n. <*CN=NULLDN*>—client: 9.45.73.212:57333-connectionID: 80826--received:

o. 2001-09-10-06:59:59.938-07:00DST--Success

p. base: ou=bluepages,o=ibm.com

q. scope: wholeSubtree

r. derefAliases: derefAlways

s. typesOnly: false

t. filter: (mail=FSERVOS@US.IBM.COM)

u. attributes: uid, cn, notesemail

v. 2001-09-10-07:00:00.066-07:00DST--V? unauthenticated Unbind--bindDN:

Lines a-j constitute a first transaction, a directory database subtree query, and a second transaction in lines k-v. As the sample indicates, the audit log may include detailed information with respect to the directory transactions such as timestamps of the binding to and unbinding from the directory (a, j, m and v); the IP address of the client from which the search request initiated (b, n); and search parameters (c-i, p-u). It is evident that the raw audit logs, while including a trove of data, are not particularly amenable to a real time analysis by a user such as a system administrator. In this format, such logs are not readily useful in making resource management decisions, or for detecting, in “real-time” system misuse or unauthorized entry or other “hacker” attacks. Thus, there is a need in the art for systems and methods for generating near “real-time” usage statistics in a distributed information processing system. There is a particular need in such systems employing a directory based protocol for managing system resources and the control of access thereto. Note that while these needs have been discussed in the context of an LDAP audit log, the same needs arise in any type of environment in which a server or servers therein maintain a server 108.

### SUMMARY OF THE INVENTION

The aforementioned needs are addressed by the present invention. Accordingly, there are provided systems and methods for generating usage statistical information that include, respectively circuitry and steps for starting an log file parser on each server of a set of servers in a distributed information processing environment. Usage information is retrieved from a database file generated by the log file parser, and preselected usage statistical information generated from the usage information from the database file.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates, in block diagram form, a distributed information processing environment which may be used in conjunction with the present invention;

FIG. 2 illustrates, in block diagram form, a data processing system in accordance with an embodiment of the present invention;

FIG. 3 illustrates, in flowchart form, a methodology in accordance with an embodiment of the present invention; and

FIG. 4 illustrates, in flowchart form, a methodology for parsing log files which may be used in conjunction with the methodology of FIG. 3.

### DETAILED DESCRIPTION

In the following description, numerous specific details are set forth to provide a thorough understanding of the present invention. For example, particular server logs may be identified, however it would be recognized by those of ordinary skill in the art that the present invention may be practiced without such specific details. In other instances, well-known circuits have been shown in block diagram form in order not to obscure the present invention in unnecessary detail.

Refer now to the drawings wherein depicted elements are not necessarily shown to scale and wherein like or similar elements are designated by the same reference numeral through the several views.

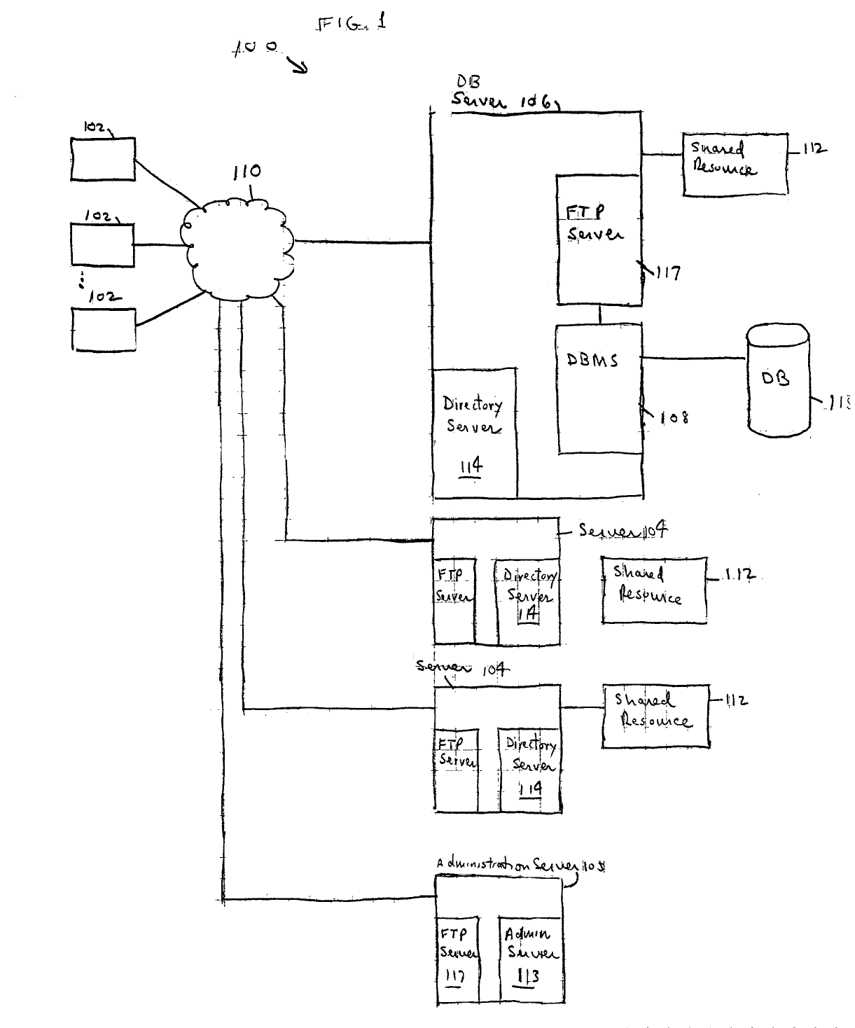

Referring to FIG. 1, there is shown therein an illustrative distributed information processing environment system 100 which may be used in conjunction with the present inventive principles. A distributed information development environment may also be referred to as a distributed data processing environment or a client-server data processing environment.) A plurality of clients 102 are connected to one or more servers 104 via network 110. Network 110 may be a local area network (LAN), wide area network (WAN) or a network system, such as the Internet, for example. It would be appreciated that the principles of the present invention to be discussed hereinbelow are not predicated on a particular network architecture. As previously described, the servers 104 may provide shared resources 112 to clients 102. Access to shared resources may be managed by directory servers 114 implemented in each of servers 104. Shared resources may include hardware resources, such as printers, or software resources such as an application service. A particular application service may be exemplified by a database management system (DBMS) 108 which manages database (DB) 115, in DB server 106. Environment 100 also includes administration server 105 which provides administrative management for servers 104 and 106 via admin server 113. (Although only one DB server is shown in the exemplary embodiment of system 100, those of ordinary skill in the art would appreciate that an information processing system in accordance with the present inventive principles may include any number of DBservers 106, as well as servers 104 It also would be appreciated that, although illustrated separately in FIG. 1, administration server 105 may be provided by implementing admin server 113 in one or more of servers 104 or server 106, and similarly, DB server 106 may be implemented as software in one or more of servers 104, and that such alternative embodiments of the architecture of environment 100 would fall within the spirit and scope of the present invention.) Additionally, directory servers 114 may themselves be viewed as an application service. In an embodiment of environment 100, in accordance therewith, a shared resource 112 may be database maintained by the directory server itself. Administration server 105 and DB server 106 may include an FTP server 117 which may be used to mediate the transfer of files there between. (An artisan of ordinary skill would recognize that an FTP server is an application that enables users to download or upload files from a specified directory or group of directories using the F(ile) T(ransfer) P(rotocol), an Internet standard for the exchange of files.)

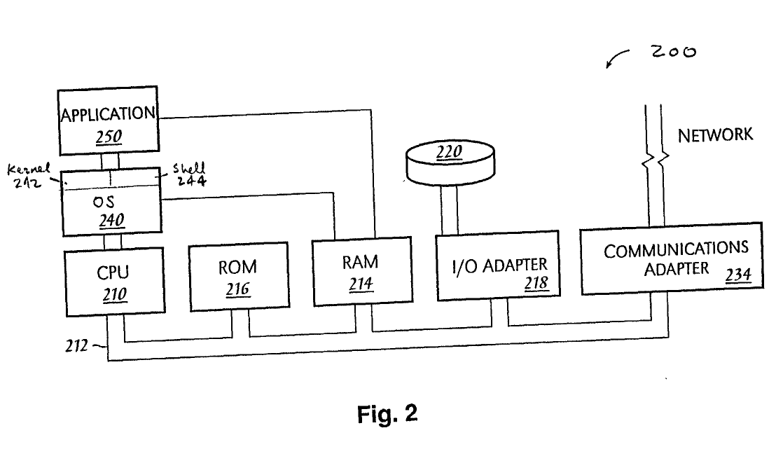

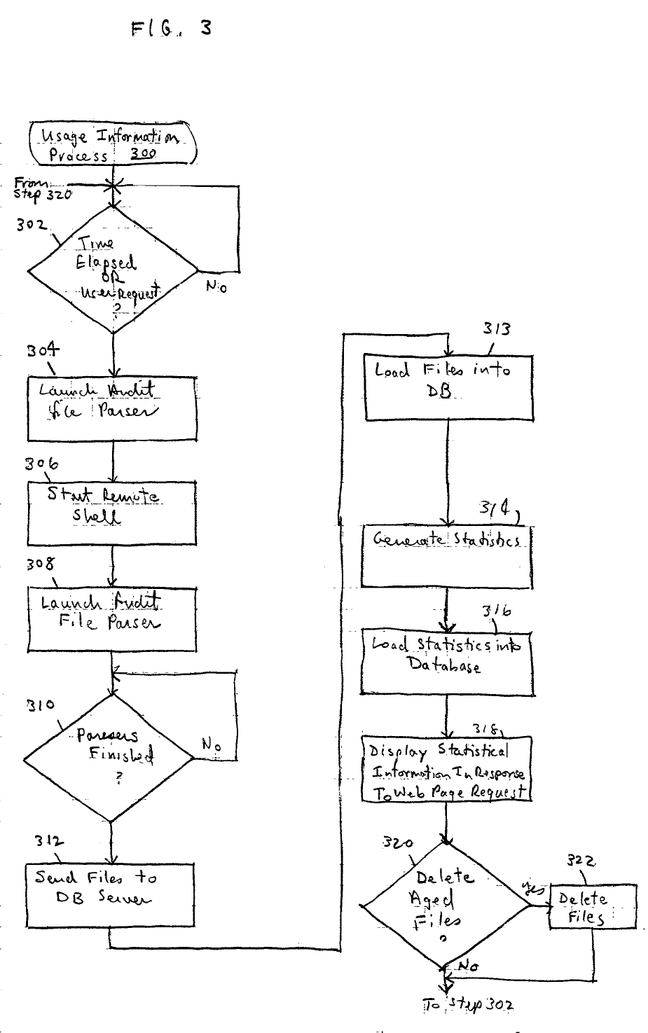

Refer now to FIG. 2 that illustrates a server 200 in accordance with the principles of the present invention. Server 200 may be used in an embodiment of servers 104, 105 server 106, FIG. 1. Server 200 may include a central processing unit (CPU) 210 coupled to various other components by system bus 212. An operating system (OS) 240 runs on CPU 210 and provides control and coordinates the function of the various components in FIG. 2. Application 250 may include directory server 114, FTP server 117. In an embodiment of a DB server, application 250 may include DBMS 108, and similarly, in an embodiment of administration server 105 may include admin server 113. Admin server 113 in conjunction with directory server 114 may include mechanisms for generating usage data and statistics in accordance with the principles of the present invention and which will be described further in conjunction further with FIGS. 3-X hereinbelow. Application 250 runs in conjunction with OS 240, which coordinates the internal functions of server 200, and may provide services to application 250 as would be understood by those of ordinary skill in the art. OS 240 may include a kernel portion 242 and a shell portion 244 (simply kernel and shell, respectively). As one of ordinary skill in the art would understand kernel 242 may provide basic operating system services such as process management and interprocess communications, and operating system services, such as I/O are provided to applications, such as application 250, via shell 244. For example, in a Unix embodiment of operating system 240, shell 244 one or more shells 244 may be provided, including the Bourne shell (bsh), the Bourne-again shell (bash), the Korn shell (ksh), the C-shell (csh) and the enhanced C-shell (tsch).

Additionally, read only memory (ROM) 216 is coupled to system bus 212 and includes a basic input/output system (BIOS) that control certain basic functions of server 200. Random access memory (RAM) 214, disk adapter 218 and communications adapter 234 are also coupled to system bus 212. It should be noted that software components including OS 240 and application 250 are loaded into RAM 214 which is the computer systems main memory. Disk adapter 218 may be a Universal Serial Bus (USB) or other adapter that communicates with disk units 220. It is noted that the program of the present invention may reside in disk unit 220 and loaded into RAM 214 by operating system 240, as required. Communications adapter 234 interconnects bus 212 with a network, such as network 110, FIG. 1.

Implementations of the invention include implementations as a computer system programmed to execute the method or methods described herein, and as a computer program product. According to the computer system implementations, sets of instructions for executing the method or methods are resident in the random access memory 214 of one or more computer systems configured generally as described above. And to require by server 200, the set of instructions may be stored as a computer program product in another computer memory, for example in disk drive 220 (which may include a removable memory such as an optical disk or floppy disk for eventual use in disk drive 220). Furthermore, the computer program product can also be stored in another computer and transmitted when desired to the work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

The flowcharts provided herein are not necessarily indicative of the serialization of operations being performed in an embodiment of the present invention. Steps disclosed within these flowcharts may be performed in parallel. The flowcharts are meant to designate those considerations must be performed to execute the generation of usage information. It is further noted that the order presented is illustrative and does not necessarily imply that the steps must be performed in order shown.

Refer now to FIG. 3 illustrating, in flowchart form, process 300 for generating usage information in accordance with the present inventive principles. Usage information may be generated in response to a manual request, or periodically. In step 302, process 300 enters a loop. If in step 302 a predetermined time interval elapses, the process breaks out of the loop, and new usage data is generated as described in conjunction with steps 302-322. Note that the timing loop portion of step 302 may be performed by a job scheduler, such as cron in a Unix embodiment of the operating system. Additionally, portions of process 300 may be performed in response to a shell script. Moreover, it would be recognized by those of ordinary skill in the art that alternative embodiments may be implemented using other scripting languages, for example, Perl or Tcl, and such alternative embodiments would be understood to fall within the spirit and scope of the present invention. Alternatively, a user, here, typically, a system administrator may request that current usage information be generated, and upon receiving such a request, step 302 also breaks out of the loop. Such a manual request may be in the form of a manual execution of the aforementioned shell, or similar, script.

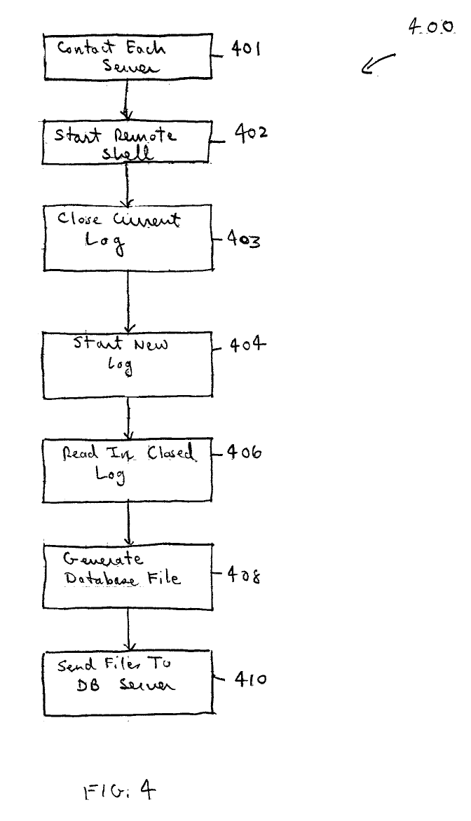

In step 308, an audit file parser is started on each server. An audit file (equivalently, an audit log or server log) may be maintained by a directory server, such as directory server 114, FIG. 1, as discussed hereinabove. (Note that, the present inventive principles may be used with any server log, an LDAP server log being an exemplary log which may be used in conjunction with the present invention.) The audit file parser generates an output file appropriately formatted for insertion in a database and for further processing to generate usage statistical information. The operation of the audit log parser in accordance with the principles of the present invention will be described in further detail in conjunction with FIG. 4.

In step 310, process 300 waits until each parser finishes, and as described in conjunction with FIG. 4, outputs a database file, containing usage data from the current log file. (A database file is a file formatted in accordance with the database management system deployed in the distributed processing environment. One example may be a “comma-delimited” file format.) After each parser finishes, step 310 breaks out of the loop and, in step 312 the files are sent to a database server such as DB server 106, FIG. 1 for incorporation into a database, for example DB 115, via DBMS 108. Files may be transferred to the database server using a remote copy (rap) operation. Alternatively, the files may be sent to the database server using FTP via FTP servers 117.

In step 312, the files are loaded into the database. In step 314, statistical information and other usage information is generated from the output (database files) created by the audit log parsers. Such information may include, for example, the number of operations (of various types) each server is handling per unit of time (hour/minute/second), which operations/services each user is accessing, peak workloads on each server, peak workloads by site (in an environment which embodies a multiplicity of geographical locations) etc. In particular, the usage statistics may include minute-by-minute bind, search, add, modify, and delete operations per server (or other temporal unit interval operation statistic), maximum operations per minute (operations may include any of bind, search, add, modify and delete operations), client utilization, that is, total operations by client IP address, (detects those who use service frequently), and daily totals (total bind, search, add, modify, and delete operations for all servers combined). Artisans of ordinary skill would understand that the aforementioned data are exemplary and that other statistics may be generated in accordance with the present inventive principles by using computational techniques employed in the statistical arts, and such embodiments would be within the spirit and scope of the present invention. The usage statistics information generated in step 314 may be loaded into the database, step 316. The database tables may be populated by running queries that include calculations to generate the usage statistics. In such an embodiment, step 314 and 316 may be performed by the query operation.

Users may access the usage information via, for example, SQL (Structured Query Language) or other database accessing methods. An example may be a Web page that performs SQL queries against the database and returns the information in a format readily accessible by the user, step 318. Moreover, it would be appreciated by those of ordinary skill in the art that additional queries may be made against the data stored in step 313, to generate statistical information in addition to that loaded into the database in step 316.

Data that is more that a preselected age, may, optionally, be deleted from the database. If it is selected to delete such aged data, step 320, in step 322, the aged data files are deleted from the database, and process 300 returns to step 302. Conversely, if aged data is to remain in the database, step 320 is bypassed.

To further appreciate process 300 for generating usage information in accordance with the principles of present invention, refer now to FIG. 4, illustrating, in flowchart form, log file parser process 400, which may be used in conjunction with step 304, FIG. 3. In step 401, each server in the environment, such as servers 104 and 106 in environment 100, FIG. 1 is contacted, and in step 402, a remote shell is started. It would be appreciated by those of ordinary skill in the art, that a remote shell operates to execute commands on a remote system, in this instance, each server in the distributed environment for which usage information is being generated. It would recognized by persons of ordinary skill in the art that in a Unix embodiment of the operating system, such as OS 240, FIG. 2, steps 304 and 308 may be implemented by invoking an rsh or rmshell command, depending on the particular shell used, with a command parameter corresponding the audit log parser. In step 403, a current log file is closed, and in step 404, a new log file is opened. In step 406, the current log (closed in step 402) is read in and parsed. In step 408 a database file is output. That is, a file formatted in accordance with the database management system deployed in the distributed processing environment and containing the usage data from the current log file is output. In an embodiment of the present invention in which the database management system is DB/2, the output file may be in the form of comma delimited tables of string literates.

Recall, that after the parser completes, the database file is used to generate usage statistical information in accordance with the methodology described in conjunction with FIG. 3. In this way, a system administrator or other user may access usage statistics in a distributed information processing environment in near real-time.

Although the present invention and its advantages have been described in detail, it should be understood that various changes, substitutions and alterations can be made herein without departing from the spirit and scope of the invention as defined by the appended claims.

What is claimed is:

1. A method comprising the steps of:
starting an log file parser on each server of a set of servers in a distributed information processing environment;
retrieving usage information from a database file generated by said log file parser; and
generating preselected usage statistical information from said usage information from said database file.

2. The method of claim 1 further comprising the steps of:
closing a current log file;
reading said log file; and
generating said database file in response to said log file.

3. The method of claim 2 further comprising the step of starting a next log file.

4. The method of claim 2 wherein said steps of closing said current log file, reading said log file, and generating said database file are performed by said log file parser.

5. The method of claim 1 wherein said steps of launching a log file parser, retrieving usage information from a database file, and generating preselected usage statistical information are repeated for each server in said distributed information processing system.

6. The method of claim 1 wherein said steps of launching a log file parser, retrieving usage information from a database file, and generating preselected usage statistical information are repeated for each server in said distributed information processing system are performed by a shell script.

7. The method of claim 1 wherein said log file comprises an log file maintained by a directory server.

8. A computer program product embodied in a machine-readable storage medium, the program product comprising programming instructions for performing the steps of:
starting an log file parser on each server of a set of servers in a distributed information processing environment;
retrieving usage information from a database file generated by said log file parser; and
generating preselected usage statistical information from said usage information from said database file.

9. The program product of claim 8 further comprising programming instructions for performing the steps of:
closing a current log file;
reading said log file; and
generating said database file in response to said log file.

10. The program product of claim 9 further comprising programming instructions for performing the step of starting a next log file.

11. The program product of claim 9 wherein said steps of closing said current log file, reading said log file, and generating said database file are performed by said log file parser.

12. The program product of claim 8 further comprising programming instructions for repeating the steps of launching a log file parser, retrieving usage information from a database file, and generating preselected usage statistical information for each server in said distributed information processing system.

13. The program product of claim 8 wherein programming instructions for performing said steps of launching a log file parser, retrieving usage information from a database file, and generating preselected usage statistical information are repeated for each server in said distributed information processing system comprise a shell script.

14. The program product of claim 8 wherein said log file comprises an log file maintained by a directory server.

15. A data processing system comprising a plurality of servers, at least one of said plurality of servers including:
circuitry operable for starting an log file parser on each server of a set of said plurality of servers in a distributed information processing environment;
circuitry operable for retrieving usage information from a database file generated by said log file parser; and
circuitry operable for generating preselected usage statistical information from said usage information from said database file.

16. The data processing system of claim 15 wherein at least one of said plurality of servers comprises:
circuitry operable for closing a current log file;
circuitry operable for reading said log file; and
circuitry operable for generating said database file in response to said log file.

17. The data processing system of claim 16 wherein at least one of said plurality of servers further comprises circuitry operable for starting a next log file.

18. The data processing system of claim 16 wherein said circuitry operable for closing said current log file, reading said log file, and generating said database file comprises circuitry operable in response to said log file parser.

19. The data processing system of claim 15 further comprising circuitry operable for repeating said launching a log file parser, retrieving usage information from a database file, and generating preselected usage statistical information for each of said set of servers in said distributed information processing system.

20. The data processing system of claim 15 wherein said circuitry operable for launching a log file parser, retrieving usage information from a database file, and generating preselected usage statistical information are repeated for each server in said distributed information processing system is operable in response to a shell script.

21. The data processing system of claim 15 wherein at least one server of said plurality of servers includes circuitry operable for providing directory services, and wherein said log file comprises an log file maintained by said directory services.
